(19) United States
(12) Patent Application Publication
(10) Pub. No.: US 2026/0280364 A1
(43) Pub. Date: Sep. 17, 2026

(54) MOTOR WITH A DEFINED DETENT TORQUE

(71) Applicant: Dr. Fritz Faulhaber GmbH & Co. KG, Schönaich (DE)

(72) Inventors: Bastian Erfinder MUND, Schönaich (DE); Ingmar BARTHOLD, Schönaich (DE); Sebastian KOHSE, Schönaich (DE)

(21) Appl. No.: 19/472,956

(22) PCT Filed: Feb. 7, 2024
(86) PCT No.: PCT/EP2024/053045

§ 371 Date: Oct. 6, 2025

(30) Foreign Application Priority Data
Apr. 6, 2023 (DE) 102023108906.4

(51) Int. Cl. H02K 1/16; H02K 3/12; H02K 7/00; H02K 11/33; H02K 21/12

(52) U.S. Cl. CPC H02K 1/16; H02K 3/12; H02K 7/003; H02K 11/33; H02K 21/12; H02K 2211/03

(57) ABSTRACT

The present invention relates to a brushless motor (1), comprising at least one stator (2), at least one rotor (3), at least one shaft (4) and at least one winding (8), wherein the rotor (3) is attached to the shaft (4), wherein the rotor (3) has at least one permanent magnet (5) with a plurality of magnetic rotor poles (5a), wherein the stator (2) has a plurality of stator teeth (6), wherein each stator tooth (6) is at least partially wound by at least one stator coil (7), and wherein the stator coils (6) form the winding (8) with at least three phases (P1, P2, P3).

The invention relates to a brushless motor, in particular for driving a component supply station of a placement machine. The motor is in particular flat and is high-pole.

Brushless motors (also referred to as BLDC motors or EC motors) are known in the prior art in a variety of configurations. The commutation is electronic, which is why such motors are characterized by a longer service life and higher speeds.

In the slotted design (Slotted BLDC motor), the coils are wound in slots on the circumference of the stator. Through the slots, a higher magnetic flux density can be achieved, which leads to higher power and higher torque. The cogging torque of slotted motors depends on many parameters, including the number of pole pairs of the rotor and the stator teeth. For most applications, attempts are made to minimize the cogging torque. High-pole brushless motors thus have high torque with low cogging torque. In this respect, these motors are particularly suitable for applications that require high performance and smooth running, e.g., as direct drives.

These properties are also desirable for drives in automation or handling technology, e.g., for driving a component supply station (feeder) of a placement machine. In the case of a placement machine, however, when using a brushless motor without or with reduced cogging torque, slipping of the belt can occur when the motor becomes de-energized. Therefore, stepper or reluctance motors are usually used for such applications. However, these often do not have sufficient torque.

Based on the aforementioned prior art, the invention is based on the object of specifying a motor, in particular for driving a component supply station of a placement machine, which generates a sufficiently high cogging torque amplitude with a high number of cogging ripples and at the same time provides high torque.

The aforementioned object is solved in a generic brushless motor according to the characterizing part of claim 1 in that at least one stator tooth of at least a first phase of the winding is designed as an extended stator tooth. The extended stator tooth has a longitudinal extension in the radial direction, in particular along a longitudinal axis L of the stator tooth, which is greater than a longitudinal extension of at least one stator tooth of remaining stator teeth of the first phase. In particular, it is also provided that the extended stator tooth is longer than all remaining stator teeth of the first phase. Preferably, it is provided that at least or exactly two stator teeth of the first phase are designed as extended stator teeth, and that the two extended stator teeth are longer than all remaining stator teeth of the first phase. In particular, the extended stator teeth are arranged opposite to each other on the circumference of the stator.

Alternatively or additionally, it is provided that the extended stator tooth has a longitudinal extension in the radial direction which is greater than a longitudinal extension of at least one stator tooth of another phase, in particular the second phase or the third phase. For example, it is provided that the longitudinal extension of the extended stator tooth is greater than the longitudinal extension of all stator teeth of the second phase and/or the third phase. Preferably, the first phase has at least or exactly two stator teeth which are designed as extended stator teeth and which are designed to be longer than all stator teeth of the second phase and/or the third phase.

It is also provided that each phase has at least one extended stator tooth, in particular at least two extended stator teeth, which are each designed to be longer than the remaining stator teeth of the respective phase.

The brushless motor according to the present invention has at least one stator, at least one rotor and at least one shaft. The shaft is advantageously rotatably mounted within the stator. The shaft is mounted in the motor housing, for example with bearings, in particular ball bearings. The motor is preferably designed as a synchronous machine, in particular as a permanent magnet synchronous motor (PMSM).

The rotor and the stator are arranged in particular in a motor housing. The rotor is attached to the shaft and has at least one permanent magnet with a plurality of magnetic rotor poles. It is also provided that the rotor has a plurality of individual permanent magnets, for example between 5 and 30 permanent magnets, in particular exactly 20 permanent magnets.

The stator has a plurality of stator teeth. Each stator tooth is at least partially, in particular completely, wound with at least one stator coil. The stator teeth are preferably arranged radially around the shaft and in particular evenly spaced from each other. The stator teeth extend in the direction of the rotor. Furthermore, the rotor poles are also arranged radially around the shaft. In particular, the rotor poles or the discrete permanent magnets are evenly spaced from each other. In particular, the rotor poles are arranged concentrically to the stator teeth. The air gap is formed between the stator teeth and the rotor poles.

The stator teeth are formed, for example, on an iron yoke. In particular, the iron yoke is designed as a laminated core. The stator coils on the stator teeth form a winding of the motor with at least three phases. The stator coils are interconnected in particular on at least one printed circuit board.

At least one phase, preferably each phase, has at least two stator teeth, of which preferably at least one is designed as an extended stator tooth. An extended stator tooth has a greater longitudinal extension in the radial direction than at least one of the other stator teeth of the first phase and/or than at least one stator tooth of at least one of the further phases. Because at least one tooth is designed as an extended stator tooth, an air gap between the extended stator tooth and an oppositely arranged rotor pole is smaller than the air gap at the other stator teeth of the first phase of the winding. This locally causes an increased magnetic flux linkage and thus an increased cogging torque between the extended stator tooth and the opposite rotor pole. As a result, the local cogging torques of the individual rotor pole or permanent magnet-stator tooth combinations do not largely cancel each other out, but a significant cogging torque remains and thus a preferred position or cogging position for the rotor results, which does not significantly influence the performance of the motor, but provides sufficient holding force.

Preferably, it is provided that the air gap between the extended stator tooth, in particular its end face oriented in the direction of the rotor, and an oppositely arranged rotor pole is between 0.1 and 1.5 mm.

The brushless motor preferably has at least one rotary encoder, in particular the rotary encoder is designed as an absolute rotary encoder. For example, it is provided that the motor has at least one magnetic rotary encoder, which is designed in particular as a magnetic absolute rotary encoder. An absolute rotary encoder has the advantage that sine commutation with simultaneous cogging torque compensation during operation is enabled.

It is further preferably provided that the rotor is designed as an inner rotor radially enclosed by the stator. Alternatively, it can be provided that the rotor is designed as an outer rotor radially enclosing the stator.

The invention has the advantage over the prior art that a very powerful, efficient motor can be specified which can simultaneously be used in applications where a cogging torque is required. The different air gaps provide at least one preferred position or cogging position which has a higher magnetic flux linkage, which leads to a defined cogging torque and in particular self-locking in this position. To achieve this advantage, the motor does not require additional components, whereby the costs for the motor are kept low.

According to one embodiment of the motor, it is provided that each phase of the winding has at least or exactly four, at least or exactly six or at least or exactly eight stator teeth with stator coil, wherein the stator teeth of a phase are arranged in pairs in groups radially opposite each other. Preferably, each of the phases has the same number of stator teeth with stator coil.

Particularly preferred is an embodiment of the motor with six stator teeth per phase, wherein three stator teeth of the phase are arranged next to each other and on the circumference opposite to the other three stator teeth of the phase. Particularly advantageous is therefore a motor with a total of eighteen stator teeth.

Furthermore, it is preferably provided that the rotor has at least or exactly 8, 10, 14, 16, 20, 22, 26 or at least or exactly 28 rotor poles. The number of rotor poles is preferably unequal to the number of stator teeth or stator slots. Preferably, the number of rotor poles of the motor is always two greater or smaller than the number of stator teeth. In combination with eighteen stator teeth, twenty rotor poles are particularly preferably provided. For example, the twenty rotor poles are realized by twenty permanent magnets.

In order to ensure in particular a symmetrical running behavior of the rotor, according to a further embodiment of the motor it is provided that at least one further stator tooth of the first phase, in particular all remaining stator teeth of the first phase, are designed shortened such that the flux linkage of the first phase approaches those of the other phases and thus symmetry is maintained. In particular, the shortened stator tooth is designed shorter in a longitudinal extension along the longitudinal axis than the stator teeth of at least one phase without extended stator tooth. In particular, the stator teeth of a phase without extended stator tooth have the same length. Preferably, all stator teeth of the second phase and the third phase are equally long, in particular longer than a shortened stator tooth and shorter than an extended stator tooth.

Preferably, an amount of the length of the extended stator tooth by which the extended stator tooth is longer compared to the length of a stator tooth of a phase without extended stator tooth is compensated by a shortening of at least one stator tooth of the phase or all stator teeth of the phase by a total of approximately the same amount.

If the winding has, for example, six stator teeth per phase with three stator teeth arranged next to each other, it has proven advantageous if the middle stator tooth is designed as an extended stator tooth. Furthermore, it is advantageously provided that at least one of the two adjacent teeth, preferably both adjacent stator teeth, are designed as shortened stator teeth. The shortened stator teeth are in particular shorter than the stator teeth of at least one phase in which no extended stator tooth is formed. Preferably, the two extended stator teeth of a phase are arranged opposite to each other on the circumference. Through these measures, it can advantageously be ensured that the flux linkage of all three phases is equal.

According to a further embodiment of the motor, it has proven particularly advantageous if it is provided that the extended stator tooth has at its free end pointing in the direction of the rotor an extension area with an end face pointing in the direction of the rotor. For example, a stator tooth, in particular the extension area, has a rectangular or square cross-section. The extension area is in particular formed integrally with the stator tooth or alternatively attached to the stator tooth, for example by material bonding, to extend the stator tooth.

The end face is advantageously designed concave and has a radius which is dimensioned such that between the end face and an oppositely arranged rotor an air gap of uniform extension is formed, i.e., the distance between end face and rotor, in particular rotor poles, is constant. The curvature of the end face is consequently adapted to the outer radius of the rotor, so that overall an air gap of uniform extension over the extension of the extended stator tooth results. In particular, the extension area protrudes from the stator coil of the extended stator tooth.

A further embodiment of the motor provides that the extension area has at least two opposing side faces. The side faces are preferably arranged such that the side faces each extend in a plane to which the rotation axis of the motor is parallel. The side faces are inclined to a longitudinal axis L of the stator tooth running centrally through the stator tooth. Preferably, the side faces each have the same inclination. In particular, the side faces are inclined such that the side faces converge toward each other in the direction of the rotation axis. In particular, an angle a between 5° and 30°, in particular about 10°, is formed between a side face and the longitudinal axis L of the extended stator tooth. This inclination has an advantageous influence on the magnetic flux and thus on the cogging torque. For example, it is provided that the two side faces are also inclined, which are each arranged in a plane that is intersected by the rotation axis only at one point. For example, the extension area has a square cross-section that decreases in the direction of the rotor.

According to a further advantageous embodiment of the motor, it is provided that a transition between at least one side face of the extension area and an end face of the extended stator tooth oriented in the direction of the rotor has at least one chamfer or a rounding. Preferably, a rounding with a radius less than or equal to 2 mm is formed. For example, the radius is between 0.05 mm and 2 mm. Through the chamfer or the rounding, the magnetic flux within the stator tooth and thus the cogging torque is also advantageously influenced.

It has proven particularly advantageous for the assembly of the motor if, according to a further embodiment, it is provided that the stator teeth are formed on at least one iron yoke, and that the iron yoke is led out of a motor housing on at least one side to serve as a mounting flange for fastening the motor. Advantageously, the iron yoke is designed as a laminated core.

It is particularly preferably provided that the iron yoke is led out of a motor housing on at least two sides, in particular on two opposite sides, to each serve as a mounting flange. Preferably, at least one, preferably two, recesses for screwing the motor are provided in the areas led out of the motor housing. Leading the iron yoke out of the motor housing also has the advantage that the overall size is reduced. Furthermore, heat is advantageously dissipated from the motor housing.

In particular, it has an advantageous effect on the overall size of the motor if, according to a further embodiment, it is provided that at least one printed circuit board with components of the motor electronics is present, and that the printed circuit board serves as at least one housing surface or part of a motor housing, in particular as the back of the housing. The stator coils are interconnected on the printed circuit board, for example. Furthermore, it is preferably provided that the rotary encoder, in particular the magnetic rotary encoder, is at least partially arranged on the printed circuit board. By using, in particular a back side of, the printed circuit board as at least one housing surface or part of a motor housing, in particular an outer surface of the motor housing, the space required for the motor, in particular a thickness of the motor, is reduced, so that the motor is advantageously flat. Preferably, the printed circuit board forms a motor cover on the back of a motor housing.

It has an advantageous effect on the manufacturing costs of the motor if, according to a further embodiment of the motor, it is provided that at least one material is molded onto the iron yoke of the stator to form a motor housing. The molding is carried out, for example, by means of a forming process, for example by means of injection molding or an additive process, e.g., a 3D printing process. For example, at least one plastic is molded onto the iron yoke, wherein the plastic forms the motor housing. Molding onto the iron yoke is advantageous because both installation space is saved and no complex assembly of a motor housing has to be carried out.

A further embodiment of the motor provides that at least two stator coils of a phase arranged next to each other are wound continuously. The stator coils are therefore not wound directly onto the stator teeth, but wound externally in a “chain” of at least two stator coils. During assembly, the chain of stator coils is fanned out and pushed over adjacent stator teeth.

Preferably, it is provided that the coils of a phase arranged next to each other are wound continuously. If a phase has, for example, six coils, three stator coils each are wound continuously and in particular pushed onto the adjacent stator teeth after winding.

This embodiment has the advantage that a simpler winding technique can be used. In addition, the effort for interconnecting the stator coils is reduced, since through the continuous winding only a smaller number of winding taps are present.

The aforementioned object is further solved by the use of a brushless motor according to one of the described embodiments for driving a conveyor belt, in particular for driving a component supply station of a placement machine.

The invention is not limited to the illustrated and described embodiments, but also includes all embodiments having the same effect within the meaning of the invention. It is expressly emphasized that the embodiments are not limited to all features in combination, rather each individual partial feature can also have inventive significance independently of all other partial features. Furthermore, the invention is also not yet limited to the feature combination defined in claim 1, but can also be defined by any other combination of specific features of all individually disclosed features. This means that in principle practically every individual feature of claim 1 can be omitted or replaced by at least one individual feature disclosed elsewhere in the application.

Further advantageous embodiments of the invention result from the following figure description and the dependent subclaims. They show:

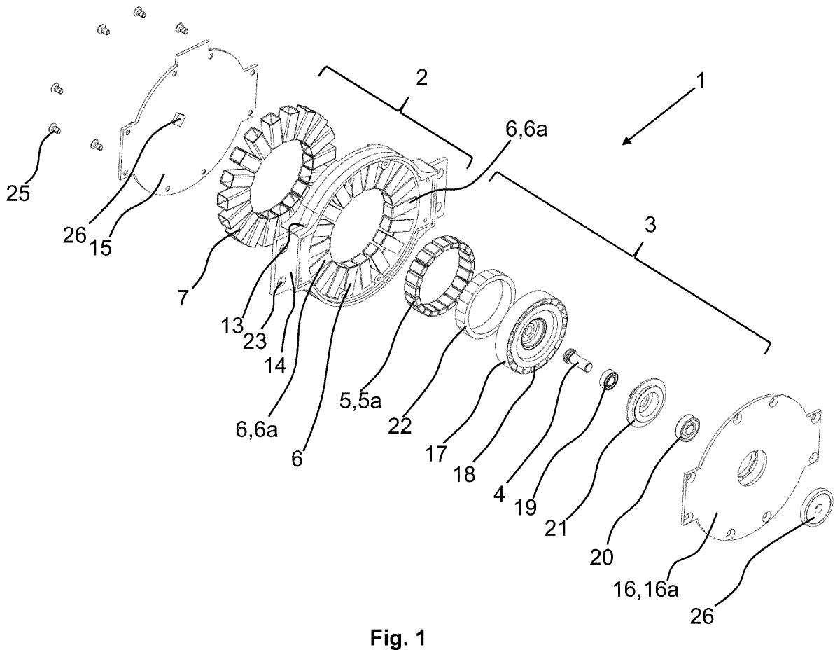

FIG. 1 an embodiment of a motor according to the invention in perspective exploded view,

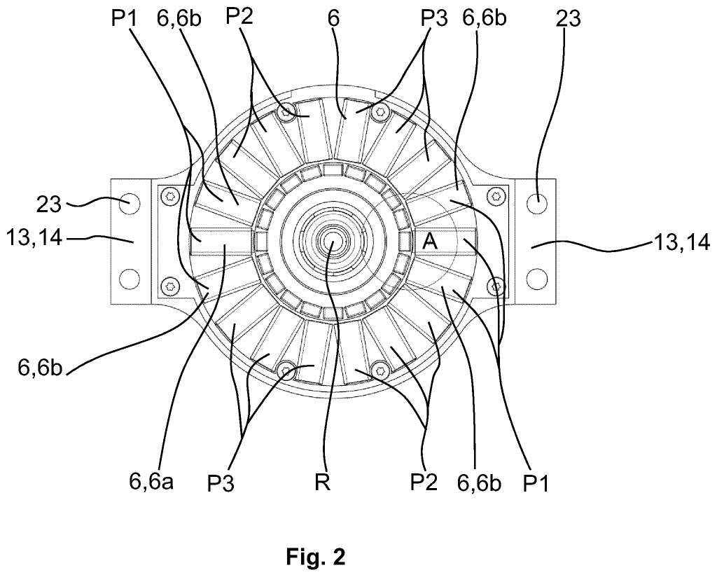

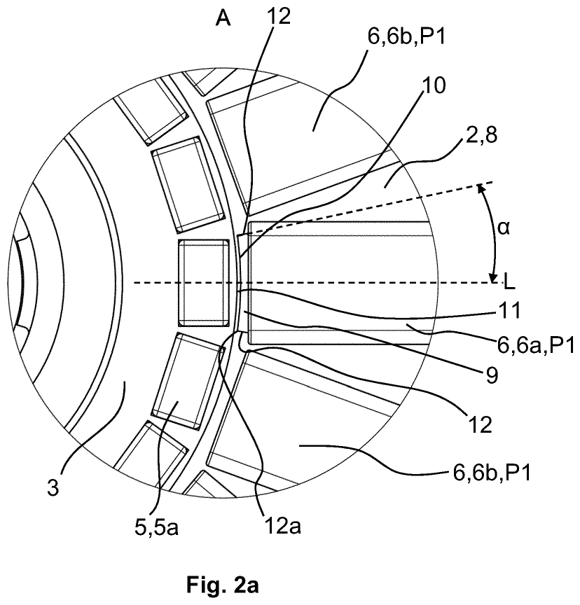

FIG. 2 the embodiment according to FIG. 1 in partially assembled state in a top view,

FIG. 2a an enlargement of FIG. 2 in area A,

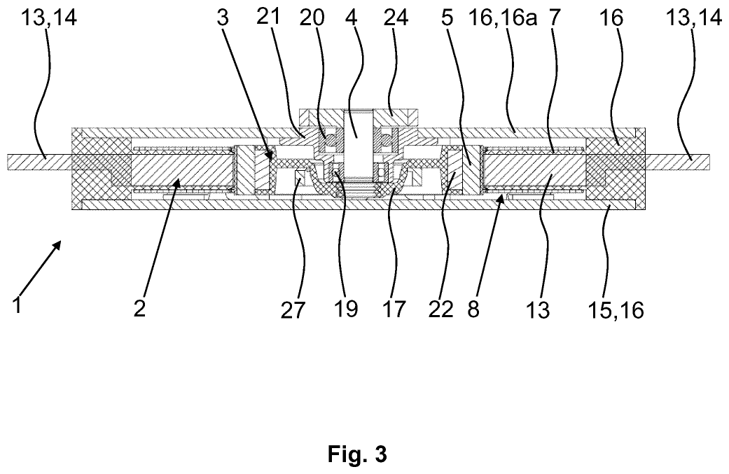

FIG. 3 a section through the embodiment according to FIG. 1, and

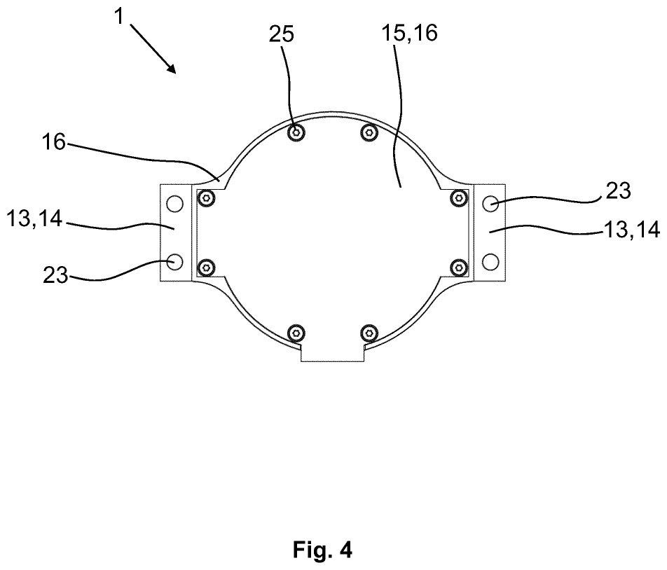

FIG. 4 a top view of the back of the embodiment according to FIG. 1 in assembled state.

In the various figures of the drawing, identical parts are always provided with the same reference numerals.

For the following description, it is claimed that the invention is not limited to the embodiments and thereby not to all or several features of described feature combinations, rather each individual partial feature of the/each embodiment is also significant for the subject matter of the invention independently of all other partial features described in connection therewith and also in combination with any features of another embodiment.

FIG. 1 to FIG. 4 show an embodiment of a brushless motor 1. FIG. 1 shows the embodiment in perspective exploded view, FIG. 2 in partially assembled state in top view, FIG. 2a shows an enlargement of FIG. 2 in area A, FIG. 3 shows a section through the rotation axis R and FIG. 4 shows a top view from the back of the motor 1.

According to FIG. 1 to 4, the motor 1 has a stator 2, a rotor 3 and a shaft 4. The shaft 4 is, for example according to FIG. 3, rotatably mounted within the stator 2 and the rotor 3 is attached to the shaft 4. The rotor 3 has a plurality of permanent magnets 5 which form a plurality of magnetic rotor poles 5a. The permanent magnets 5 are arranged in a hub 17 of the rotor 3. The permanent magnets 5 are arranged in receiving pockets 18 in the hub 17. The receiving pockets 18 are arranged evenly distributed over the circumference of the hub 17. The rotor 3 further has a first bearing 19, a second bearing 20, a bearing flange 21 and a rotor yoke 22. The stator 2 has a plurality of stator teeth 6 which are formed on an iron yoke 13. Each stator tooth 6 is at least partially wound with a stator coil 7, wherein the stator coils 7, in particular according to FIG. 2, form a winding 8 with three phases P1, P2, P3.

According to FIG. 2, a first phase P1 comprises six stator teeth 6, a second phase P2 six stator teeth 6 and a third phase P3 also six stator teeth 6. Three each of the stator teeth 6 of the phases P1, P2, P3 are arranged opposite to each other on the circumference of the stator 2. The stator teeth 6 with the stator coils 7 are evenly distributed over the circumference of the stator 2.

According to the invention, it is provided that two stator teeth 6a of the first phase P1 are designed as extended stator teeth 6a, which are designed longer in relation to their longitudinal extension along the longitudinal axis L—see in particular FIG. 2a—of a stator tooth 6, 6a than the other stator teeth 6b of the first phase P1. The two extended stator teeth 6, 6a are designed longer than all stator teeth of the second phase P2 and the third phase P3. All stator teeth 6 of the second phase P2 and the third phase P3 are designed equally long.

In particular according to FIG. 2 and the enlargement in FIG. 2a, the air gap 11 between a stator tooth 6, 6a and the opposite rotor 3 is locally reduced by the extended stator teeth 6a, whereby the rotor 3 receives a preferred or cogging position at which a defined cogging torque prevails. In this embodiment, the extended stator teeth 6a are arranged in the middle between the respective other two stator teeth 6b of the first phase P1. The two extended stator teeth 6a of the first phase are arranged opposite to each other on the circumference of the stator 2.

To ensure symmetrical running behavior of the rotor 3, the remaining stator teeth 6b of the first phase P1 are designed as shortened stator teeth 6, 6b. The shortened stator teeth 6, 6b are designed shorter than the stator teeth 6 of the second phase P2 and the third phase P3. The four shortened stator teeth 6, 6b are designed equally long. This results in an advantageous cogging position as well as advantageously symmetrical running behavior of the rotor 3.

The extended stator teeth 6a have, for example according to FIGS. 2 and 2a, an extension area 9 which is oriented in the direction of the rotor 3 and protrudes from the stator coil 7 in the direction of the rotor 3 in the extended stator teeth 6, 6a. The extension area 9 is formed integrally with the stator tooth 6, 6a, for example by being punched out as an extended stator tooth 6, 6a.

The extension area 9 has an end face 10 pointing in the direction of the rotor 3, which is concavely curved to make the air gap 11 uniform over the extension of the extended stator tooth 6a to the rotor 3. The air gap 11 has a uniform extension over the width of the extension area 9 respectively the end face 10 has a constant distance to the rotor 3. Furthermore, two side faces 12 are formed on the extension area 9, which are each arranged in an imaginary plane to which the rotor axis R is parallel. The side faces 12 are inclined at an angle a of about 10° to the longitudinal axis L of the extended stator tooth 6, 6a. The longitudinal axis L is a radial to the rotation axis R. In both transitions 12a from the side faces 12 to the end face 10, a chamfer not shown in detail is formed in this embodiment.

According to FIG. 1 to 4, the motor 1 has an iron yoke 13 on which the stator teeth 6 are formed. The iron yoke 13 is designed as a laminated core and extends out of a motor housing 16 on two opposite sides. The areas of the iron yoke protruding from the motor housing 16 each form a mounting flange 14 with two recesses 23 each for fastening the motor 1. The motor housing 16 has been molded onto the iron yoke by a forming process, here injection molded. The motor housing 16 is made of a plastic.

The motor housing 16 is closed on a front side, where the shaft 4 exits from the motor housing 16, by a front motor cover 16a. On the back of the motor housing 16, a printed circuit board 15 forms the rear housing part of the motor housing 16. On the printed circuit board 15, the coils 7 are interconnected. A sensor chip 26 of the magnetic absolute encoder-not shown in detail-is arranged on the printed circuit board 15. A magnetic ring 27 of the absolute encoder, i.e., its measuring standard, is shown in FIG. 3. The magnetic ring 27 is attached to the hub 17. According to FIG. 1 and FIG. 4, the printed circuit board 15 is screwed to the motor housing 16 with a plurality of screws 25. The front motor cover 16a is also screwed to the motor housing 16. Because the printed circuit board 15 forms the rear housing part of the motor housing 16, the overall height of the motor 1 can be significantly reduced.

The shaft 4 is mounted in the motor housing 16 with the first bearing 19 and the second bearing 20 via a bearing flange 21. The bearing flange 21 is arranged in a recess in the front motor cover 16a. Outside the motor housing 16, a pinion 24 is connected to the shaft 4. The pinion 24 serves to connect the motor 1 to an application.

FIG. 4 shows a rear top view of the motor 1. The motor housing 16 is closed on the back with the printed circuit board 15, which is screwed to the motor housing 16 with screws 25. The iron yoke 13 protrudes laterally from the motor housing 16 to serve as a mounting flange 14 with two recesses 23 each for fastening the motor 1.

The invention is not limited to the illustrated and described embodiments, but also includes all embodiments having the same effect within the meaning of the invention. It is expressly emphasized that the embodiments are not limited to all features in combination, rather each individual partial feature can also have inventive significance independently of all other partial features. Furthermore, the invention is also not yet limited to the feature combination defined in claim 1, but can also be defined by any other combination of specific features of all individually disclosed features. This means that in principle practically every individual feature of claim 1 can be omitted or replaced by at least one individual feature disclosed elsewhere in the application.

### LIST OF REFERENCE NUMERALS

1 Motor
2 Stator
3 Rotor
4 Shaft
5 Permanent magnet
5a Rotor pole
6 Stator tooth
6a Extended stator tooth
6b Shortened stator tooth
7 Stator coil
8 Winding
9 Extension area
10 End face
11 Air gap
12 Side face
12a Transition
13 Iron yoke
14 Mounting flange
15 Printed circuit board
16 Motor housing
16a Front motor cover
17 Hub
18 Receiving pocket
19 First bearing
20 Second bearing
21 Bearing flange
22 Rotor yoke
23 Recess
24 Pinion
25 Screw
26 Sensor chip
27 Magnetic ring
a Angle
L Longitudinal axis
R Rotation axis
P1 First phase
P2 Second phase
P3 Third phase

1. Motor comprising at least one stator, at least one rotor, at least one shaft and at least one winding, wherein the rotor is attached to the shaft, wherein the rotor has at least one permanent magnet with a plurality of magnetic rotor poles, wherein the stator has a plurality of stator teeth, wherein each stator tooth is at least partially wound by at least one stator coil , and wherein the stator coils form the winding with at least three phases,
wherein
at least one stator tooth of at least a first phase of the winding is designed as an extended stator tooth and that the extended stator tooth has a longitudinal extension in the radial direction which is greater than a longitudinal extension of at least one stator tooth of remaining stator teeth of the first phase and/or which is greater than a longitudinal extension of at least one stator tooth of at least one of the remaining phases.

2. The motor according to claim 1,
wherein
each phase the winding has at least or exactly two, at least or exactly four, at least or exactly six or at least or exactly eight stator teeth with stator coil, that the stator teeth of a phase are each arranged in pairs radially opposite to each other, preferably that each of the phases has an equal number of stator teeth with stator coil.

3. The motor according to claim 2,
wherein characterized in that
each phase of the winding has six stator teeth, so that three stator teeth each are arranged opposite to each other, and that the two middle stator teeth of at least the first phase are designed as extended stator teeth.

4. The motor according to claim 1,
wherein
at least one further stator tooth of the first phase is designed as a shortened stator tooth such that the rotor overall has the most symmetrical running behavior possible.

5. The motor according to claim 1,
wherein
the extended stator tooth has at its free end pointing in the direction of the rotor an extension area with an end face pointing in the direction of the rotor, that the end face is designed concave and has a radius, and that the radius is dimensioned such that between the end face and an oppositely arranged rotor an air gap with uniform extension is formed.

6. The motor according to claim 5,
wherein
the extended stator tooth has at its free end pointing in the direction of the rotor an extension area with at least two opposing side faces, and that the side faces are inclined to a longitudinal axis of the extended stator tooth.

7. The motor according to claim 6,
wherein
a transition between at least one side face of the extension area and an end face of the extended stator tooth oriented in the direction of the rotor has at least one chamfer or a rounding.

8. The motor according to claim 1,
wherein
the stator teeth are formed on at least one iron yoke, and that the iron yoke is led out of a motor housing on at least one side to serve as a mounting flange for fastening the motor.

9. The motor according to claim 1,
wherein characterized in that
at least one printed circuit board, is present, and that the printed circuit board serves as at least one housing surface of a motor housing.

10. The motor according to claim 1,
wherein
at least one material is molded onto an iron yoke of the stator to form a motor housing.

11. The motor according to claim 1,
wherein
at least two stator coils of a phase arranged next to each other are wound continuously.

12. Use of a brushless motor according to claim 1 for driving a component supply station of a placement machine.

13. The motor according to claim 4,
wherein the shortened stator tooth is designed shorter than stator teeth of at least one phase without extended stator tooth.

14. The motor according to claim 6,
wherein an angle a between 5° and 30° is formed between a side face and the longitudinal axis L of the extended stator tooth.

15. The motor according to claim 8,
wherein the iron yoke is designed as a laminated core.

16. The motor according to claim 1,
wherein at least one printed circuit board with components of the motor electronics is present.

17. The motor according to claim 9,
wherein the printed circuit board serves as the back of the motor housing.

18. The motor according to claim 1,
wherein at least one plastic is molded onto an iron yoke of the stator to form a motor housing.

19. The motor according to claim 1,
wherein at least or exactly three stator coils of a phase arranged next to each other are wound continuously.

20. The motor according to claim 11,
wherein the stator coils have been pushed together onto adjacent stator teeth after winding.
